(19) United States
(12) Patent Application Publication
(10) Pub. No.: US 2014/0041472 A1
(43) Pub. Date: Feb. 13, 2014

(54) TRANSMISSION

(71) Applicant: Fuji Jukogyo Kabushiki Kaisha, Tokyo (JP)

(72) Inventors: Yasuyuki Ukon, Tokyo (JP); Keisuke Shibuya, Tokyo (JP)

(73) Assignee: Fuji Jukogyo Kabushiki Kaisha, Tokyo (JP)

(21) Appl. No.: 13/948,023

(22) Filed: Jul. 22, 2013

(30) Foreign Application Priority Data
Aug. 8, 2012 (JP) 2012-176409

(51) Int. Cl. F16H 3/083

(52) U.S. Cl. CPC F16H 3/083
USPC 74/339

(57) ABSTRACT

A transmission includes an input shaft for receiving rotation of an engine, an intermediate shaft connected to the input shaft via a damping mechanism, drive gears, driven gears, and an output shaft. Rotation of the input shaft is transmitted to the driven gears, which are inserted into the output shaft to be free to rotate, via the damping mechanism, the intermediate shaft, and the drive gears. A gear shift is performed by fixing one of the driven gears to the output shaft to be incapable of relative rotation using a selector mechanism. An impact generated when the gear is fixed is absorbed and dampened by the damping mechanism, which is interposed between the input shaft and the intermediate shaft.

### CROSS-REFERENCE TO RELATED APPLICATIONS

The present application claims priority from Japanese Patent Application No. 2012-176409, filed on Aug. 8, 2012, the entire contents of which are hereby incorporated by reference.

### BACKGROUND OF THE INVENTION

1. Field of the Invention

The present invention relates mainly to transmissions for vehicles.

2. Description of the Related Art

Examples of a dog type transmission that performs gear shifts without disengaging a clutch provided between an engine and the transmission includes a transmission disclosed in Japanese Unexamined Patent Application Publication (Translation of PCT Application) (JP-T) No. 2009-536713 The dog type transmission includes a low speed gear and a high speed gear attached to an output shaft so as to freely rotate, a hub fixed to the shaft between the low speed gear and the high speed gear, and a first key and a second key that attached to the hub so as to move freely in an axial direction and rotate integrally therewith in a circumferential direction.

According to this transmission, when the first key and the second key are moved to the low speed gear by an actuator during acceleration, for example, the first key engages with a dog provided on a side face of the low speed gear such that power transmission between the low speed gear and the hub is realized by the first key alone. At this time, the second key is disengaged from the low speed gear and can therefore be moved to the high speed gear while power transmission via the first key is underway.

When the second key is moved to the high speed gear, the second key engages with a dog provided in a side face of the high speed gear such that power transmission between the high speed gear and the hub is realized by the second key. When a power transmission path is switched from the low speed gear to the high speed gear, a rotation speed of the shaft decreases, and therefore the engagement between the first key and the low speed gear is released at the same time as the switch in the power transmission path so that the first key can be switched to the high speed gear. By moving the first key to the high speed gear, a gear shift from the low speed gear to the high speed gear can be completed without causing torque interruption.

In the transmission described above, however, each of the key is engaged with the corresponding gear in a condition where a rotation difference exists between the key and the gear, and therefore, when the key engages with the dog of the gear, torque variation (to be referred to hereafter as “spike torque”) occurs in which the torque jumps momentarily and then returns to normal. When spike torque is generated during a gear shift in this manner, an impact sound is generated by the engagement between the key and the dog, noise is generated when an outer race of a bearing that supports the shaft impinges on a transmission cas. Moreover, the spike torque may generate torsion in the shaft, which causes vibration in a drive wheel and the transmission case.

Hence, a transmission that suppresses noise and vibration by incorporating a damping mechanism having an elastic body in a gear in order to absorb the spike torque, such as that disclosed in Japanese Unexamined Patent Application Publication (Translation of PCT Application) (JP-T) No. 2010-510464, has been proposed.

However, when a damping mechanism is incorporated into a gear, as disclosed in JP-T No. 2010-510464, a thickness of the gear decreases, leading to a reduction in rigidity, and as a result, a meshing precision of the gear deteriorates, causing an increase in meshing noise. Further, when the gear has a particularly small diameter, only a small damping mechanism can be incorporated therein, making it impossible to secure a sufficient damping function. Moreover, damping mechanisms are incorporated into gears of all speeds, leading not only to an increase in cost but also an increase in a shaft length of the shaft and a corresponding increase in an overall size of the transmission.

### SUMMARY OF THE INVENTION

The present invention has been designed in consideration of the circumstances described above, and an object thereof is to provide a transmission that achieves reductions in the cost and the size of a transmission while securing a sufficient damping function for dampening spike torque generated during a gear shift.

An aspect of the present invention provides a transmission including: an input shaft for receiving rotation of an engine; an intermediate shaft disposed concentrically with the input shaft to be capable of rotating relative thereto; an output shaft disposed parallel to the intermediate shaft; at least one first drive gear fixed to the intermediate shaft; one or a plurality of second drive gears disposed in series to be respectively free to rotate on an axis extending from a shaft end of the intermediate shaft; a shaft joining mechanism to join a gear that is closest to the intermediate shaft, from among the second drive gears, to the intermediate shaft to be incapable of relative rotation; at least one first driven gear that is inserted into the output shaft to be free to rotate and meshes with the first drive gear; one or a plurality of second driven gears inserted into the output shaft to be free to rotate and meshes with the one or plurality of second drive gears; a selector mechanism to fix one of the at least one first driven gear and the one or the plurality of second driven gears to the output shaft to be incapable of relative rotation; and a damping mechanism interposed between the input shaft and the intermediate shaft to absorb an impact generated when one of the at least one first driven gear and the one or plurality of second driven gears is fixed to the output shaft to be incapable of relative rotation by the selector mechanism.

When the second drive gears is provided in a plurality, the transmission may further include a gear joining mechanism to join adjacent second drive gears to each other to be incapable of relative rotation.

The second drive gears may be disposed such that gear ratios thereof decrease gradually away from an engine side end of the input shaft.

The damping mechanism may have a function for causing the input shaft and the intermediate shaft to rotate integrally when a torque generated in the input shaft or the intermediate shaft is smaller than a predetermined torque, and causing the input shaft and the intermediate shaft to rotate relatively when the torque equals or exceeds the set torque.

The damping mechanism may include: an input shaft friction plate that rotates integrally with the input shaft; an intermediate shaft friction plate that is disposed to overlap the input shaft friction plate and rotates integrally with the intermediate shaft; and an elastic member for pressing the intermediate shaft friction plate against the input shaft friction plate.

The intermediate shaft may be hollow, the input shaft may penetrate the hollow intermediate shaft and include a projecting shaft that projects from an end thereof, and the second drive gears may be inserted into the projecting shaft to be free to rotate.

The selector mechanism may include: dogs that project respectively from opposing surfaces of adjacent gears, from among the first driven gears and the second driven gears inserted into the output shaft to be free to rotate; a hub fixed to the output shaft between the adjacent gears; a first key held on the hub to be free to move in an axial direction of the output shaft, one end of which can be engaged with a leading surface of the dog projecting from one of the adjacent gears and another end of which can be engaged with a trailing surface of the dog projecting from the other adjacent gear; a second key held on the hub to be free to move in the axial direction of the output shaft, one end of which can be engaged with the trailing surface of the dog projecting from one of the adjacent gears and another end of which can be engaged with the leading surface of the dog projecting from the other adjacent gear; and an actuator for moving the first key and the second key in the axial direction of the output shaft.

A plurality of key grooves extending in the axial direction may be formed in an outer peripheral surface of the hub at intervals in a circumferential direction, and the first key and the second key may be held in the key grooves alternately in the circumferential direction.

When a gear shift is performed in the transmission according to the present invention, one of the first driven gears and second driven gears inserted into the output shaft to be free to rotate is fixed to the output shaft to be incapable of relative rotation by the selector mechanism. An impact (spike torque) generated at this time is absorbed by the damping mechanism interposed between the input shaft and the intermediate shaft.

The damping mechanism is shared among all gear positions and is therefore able to respond to spike torque generated when any one of the first driven gears and second driven gears is fixed to the output shaft to be incapable of relative rotation. Further, in contrast to the related art, the damping mechanism is not incorporated into a gear interior, and therefore the damping function is not limited by dimensional restrictions.

### BRIEF DESCRIPTION OF THE DRAWINGS

FIG. 1 is a schematic diagram of a transmission for a vehicle according to an embodiment of the present invention;

FIG. 2 is an exploded perspective view illustrating a selector mechanism (a first and second gear selector mechanism) of the transmission;

FIG. 3 is a perspective assembly drawing of the first and second gear selector mechanism;

FIG. 4A is a sectional view of the first and second gear selector mechanism, and FIG. 4B is an illustrative view illustrating a dog, a first key, and a second key of the first and second gear selector mechanism;

FIG. 5 is a sectional view illustrating a damping mechanism of the transmission;

FIG. 6 is an illustrative view illustrating the transmission when a first gear is selected;

FIG. 7 is an illustrative view illustrating the transmission when a second gear is selected;

FIG. 8 is an illustrative view illustrating the transmission when a third gear is selected;

FIG. 9 is an illustrative view illustrating the transmission when a fourth gear is selected;

FIG. 10 is an illustrative view illustrating the transmission when a fifth gear is selected; and

FIG. 11 is an illustrative view illustrating the transmission when a sixth gear is selected.

### DESCRIPTION OF THE PREFERRED EMBODIMENTS

A preferred embodiment of the present invention will be described in detail below with reference to the attached drawings. Dimensions, materials, and other specific numerical values and the like indicated in this embodiment are merely examples for facilitating comprehension of the invention and, excluding specific cases to the contrary, are not intended to limit the present invention. Note that elements having substantially identical functions and configurations have been allocated identical reference symbols in the specification and drawings, and duplicate description thereof has been omitted. Further, elements not directly related to the present invention have been omitted from the drawings.

(Input Shaft 1, Intermediate Shaft 2, and Output Shaft 3)

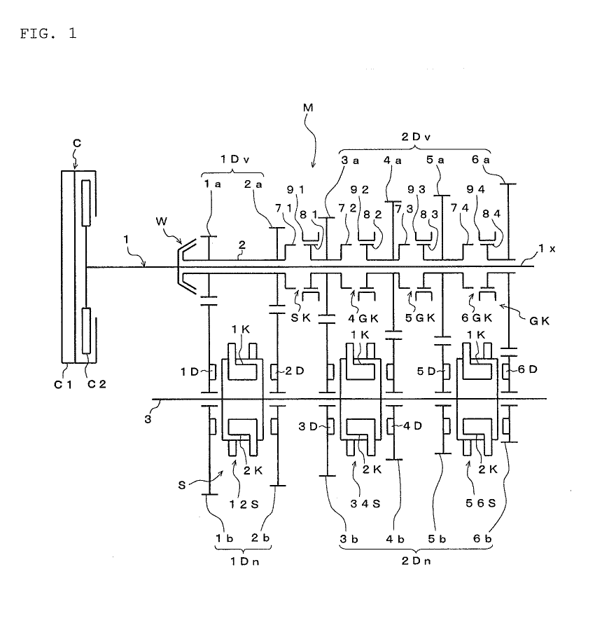

FIG. 1 schematically illustrates a transmission M for a vehicle according to an embodiment of the present invention. The transmission M according to this embodiment includes an input shaft 1 into which rotation of an engine is input, an intermediate shaft 2 disposed concentrically with the input shaft 1 to be capable of rotating relative thereto, and an output shaft 3 disposed parallel to the intermediate shaft 2. The shafts 1, 2, 3 are supported on a transmission case of the transmission M to be free to rotate via respective bearings.

The input shaft 1 has a startup clutch C is provided on an end thereof. The clutch C includes a drive plate C1 connected to a rotary shaft (a crankshaft) of the engine and a driven plate C2 connected to the input shaft 1. When the vehicle (automobile) is to be started, the clutch C has a function for starting the vehicle from a condition in which the transmission M is set in a startup gear position (a first gear, for example) by transmitting rotation of the crankshaft to the input shaft 1 while the drive plate C1 and the driven plate C2 are in close contact.

The intermediate shaft 2 is hollow, and the input shaft 1 is inserted into the intermediate shaft 2 concentrically therewith to be capable of rotating relative thereto. The input shaft 1 includes a projecting shaft 1x projecting from an end of the intermediate shaft 2. The output shaft 3 is disposed parallel to the projecting shaft 1x of the input shaft 1 and the intermediate shaft 2. The output shaft 3 outputs rotation following a gear shift, and is connected to a drive wheel of the vehicle.

(First Drive Gears 1Dv)

As illustrated in FIG. 1, the transmission M includes first drive gears 1Dv provided on the intermediate shaft 2. In this Embodiment, the first drive gears 1Dv have a first speed drive gear 1a and a second speed drive gear 2a, which are fixed to the intermediate shaft 2. Note that the first drive gears 1Dv are not limited to the first speed drive gear 1a and the second speed drive gear 2a, and may have the first speed drive gear 1a alone, first speed to third speed drive gears, or four or more drive gears.

(Second Drive Gears 2Dv)

As illustrated in FIG. 1, the transmission M includes a plurality of second drive gears 2Dv disposed in series on an axis extending from a shaft end of the intermediate shaft 2. In this embodiment, the second drive gears 2Dv have a third speed drive gear 3a, a fourth speed drive gear 4a, a fifth speed drive gear 5a, and a sixth speed drive gear 6a, which are inserted into the projecting shaft 1x of the input shaft 1 to be free to rotate. Note that the second drive gears 2Dv are not limited to the four gears described above, and may have one or more gears.

The third speed drive gear 3a, fourth speed drive gear 4a, fifth speed drive gear 5a, and sixth speed drive gear 6a constituting the second drive gears 2Dv are disposed such that respective gear ratios thereof decrease gradually (i.e. toward gradually higher speed gears) from the startup clutch C serving as an engine side end of the input shaft 1. Meanwhile, in this embodiment, the first speed drive gear 1a and the second speed drive gear 2a constituting the first drive gears 1Dv are likewise disposed such that respective gear ratios thereof decrease gradually from the startup clutch C. However, the first speed drive gear 1a and the second speed drive gear 2a may be disposed in reverse.

(Shaft Joining Mechanism SK)

As illustrated in FIG. 1, the transmission M includes a shaft joining mechanism SK for joining the third speed drive gear 3a, which is the second drive gear 2Dv closest to the intermediate shaft 2, to the intermediate shaft 2 to be incapable of relative rotation. The shaft joining mechanism SK includes a hub 71 attached to the shaft end of the intermediate shaft 2 to be incapable of relative rotation, a hub 81 attached to the third speed drive gear 3a to be incapable of relative rotation, and a sleeve 91 that is engaged to the hub 81 by a spline or the like to be free to move in an axial direction but incapable of relative rotation in the circumferential direction. An engagement groove with which a shift fork engages is formed in an outer peripheral surface of the sleeve 91 in the circumferential direction. The shift fork is moved parallel to the axial direction of the projecting shaft 1x by an actuator (an electric cylinder or the like).

When the sleeve 91 is moved to the intermediate shaft 2, the sleeve 91 engages with the hub 71 of the intermediate shaft 2 while remaining engaged to the hub 81 of the third speed drive gear 3a such that the sleeve 91 is suspended between the hub 71 of the intermediate shaft 2 and the hub 81 of the third speed drive gear 3a. As a result, the third speed drive gear 3a rotates integrally with the intermediate shaft 2. When the sleeve 91 is moved to the third speed drive gear 3a, on the other hand, the sleeve 91 is uncoupled from the hub 71 of the intermediate shaft 2, and therefore the third speed drive gear 3a is disconnected from the rotation of the intermediate shaft 2. A synchromesh mechanism (a synchronization mechanism) is provided between the sleeve 91 and the hub 71 of the intermediate shaft 2.

(Gear Joining Mechanism GK)

As illustrated in FIG. 1, the transmission M includes a gear joining mechanism GK for joining adjacent gears, from among the third speed drive gear 3a, the fourth speed drive gear 4a, the fifth speed drive gear 5a, and the sixth speed drive gear 6a constituting the second drive gears 2Dv, to each other to be incapable of relative rotation. The gear joining mechanism GK is has a fourth speed gear joining mechanism 4GK provided between the third speed drive gear 3a and the fourth speed drive gear 4a, a fifth speed gear joining mechanism 5GK provided between the fourth speed drive gear 4a and the fifth speed drive gear 5a, and a sixth speed gear joining mechanism 6GK provided between the fifth speed drive gear 5a and the sixth speed drive gear 6a.

The fourth speed gear joining mechanism 4GK includes a hub 72 attached to the third speed drive gear 3a to be incapable of relative rotation, a hub 82 attached to the fourth speed drive gear 4a to be incapable of relative rotation, and a sleeve 92 that is engaged to the hub 82 by a spline or the like to be free to move in the axial direction but incapable of relative rotation in the circumferential direction. An engagement groove with which a shift fork engages is formed in an outer peripheral surface of the sleeve 92 in the circumferential direction. The shift fork is moved parallel to the axial direction of the projecting shaft by an actuator (an electric cylinder or the like).

When the sleeve 92 is moved to the third speed drive gear 3a, the sleeve 92 engages with the hub 72 of the third speed drive gear 3a while remaining engaged to the hub 82 of the fourth speed drive gear 4a such that the sleeve 92 is suspended between the hub 72 of the third speed drive gear 3a and the hub 82 of the fourth speed drive gear 4a. As a result, the fourth speed drive gear 4a rotates integrally with the third speed drive gear 3a. When the sleeve 92 is moved to the fourth speed drive gear 4a, on the other hand, the sleeve 92 is uncoupled from the hub 72 of the third speed drive gear 3a, and therefore the fourth speed drive gear 4a is disconnected from the rotation of the third speed drive gear 3a. A synchromesh mechanism (a synchronization mechanism) is provided between the sleeve 92 and the hub 72 of the third speed drive gear 3a.

The fifth speed gear joining mechanism 5GK and the sixth speed gear joining mechanism 6GK are configured similarly to the fourth speed gear joining mechanism 4GK. Therefore, description of the fifth speed gear joining mechanism 5GK and the sixth speed gear joining mechanism 6GK has been omitted.

(First Driven Gears 1Dn)

As illustrated in FIG. 1, the transmission M includes first driven gears 1Dn that are inserted into the output shaft 3 so as to mesh with the first drive gears 1Dv. The first driven gears 1Dn have a first speed driven gear 1b and a second speed driven gear 2b, which mesh respectively with the first speed drive gear 1a and the second speed drive gear 2a constituting the first drive gears 1Dv. The first speed driven gear 1b and the second speed driven gear 2b are respectively inserted into the output shaft 3 to be free to rotate.

(Second Driven Gears 2Dn)

As illustrated in FIG. 1, the transmission M includes second driven gears 2Dn that are inserted into the output shaft 3 so as to mesh with the second drive gears 2Dv. The second driven gears 2Dn have a third speed driven gear 3b, a fourth speed driven gear 4b, a fifth speed driven gear 5b, and a sixth speed driven gear 6b, which mesh respectively with the third speed drive gear 3a, the fourth speed drive gear 4a, the fifth speed drive gear 5a, and the sixth speed drive gear 6a constituting the second drive gears 2Dv. The third speed driven gear 3b, the fourth speed driven gear 4b, the fifth speed driven gear 5b, and the sixth speed driven gear 6b are respectively inserted into the output shaft 3 to be free to rotate.

(Selector Mechanism S)

As illustrated in FIG. 1, the transmission M includes a selector mechanism S for fixing one of the first speed driven gear 1b, the second speed driven gear 2b, the third speed driven gear 3b, the fourth speed driven gear 4b, the fifth speed driven gear 5b, and the sixth speed driven gear 6b to the output shaft 3 to be incapable of relative rotation. The selector mechanism S has a first and second gear selector mechanism 12S for fixing the first speed driven gear 1b or the second speed driven gear 2b to the output shaft 3 to be incapable of relative rotation, a third and fourth gear selector mechanism 34S for fixing the third speed driven gear 3b or the fourth speed driven gear 4b to the output shaft 3 to be incapable of relative rotation, and a fifth and sixth gear selector mechanism 56S for fixing the fifth speed driven gear 5b or the sixth speed driven gear 6b to the output shaft 3 to be incapable of relative rotation. The first and second gear selector mechanism 12S, the third and fourth gear selector mechanism 34S, and the fifth and sixth gear selector mechanism 56S are all configured similarly, and therefore only the first and second gear selector mechanism 12S will be described.

(Dogs 1D and 2D)

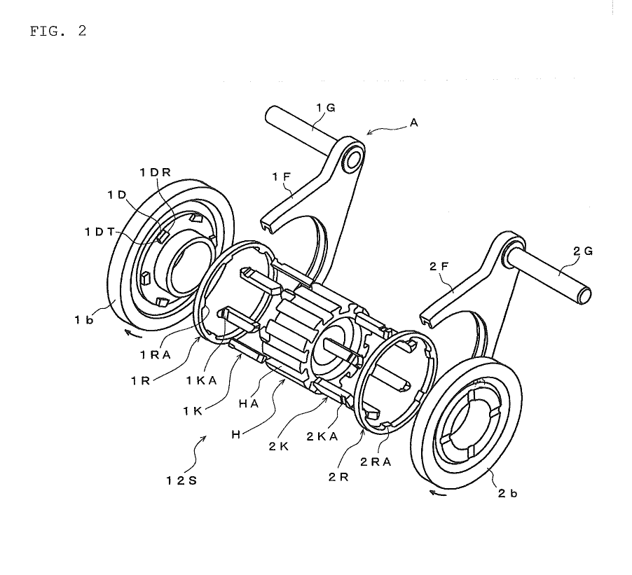

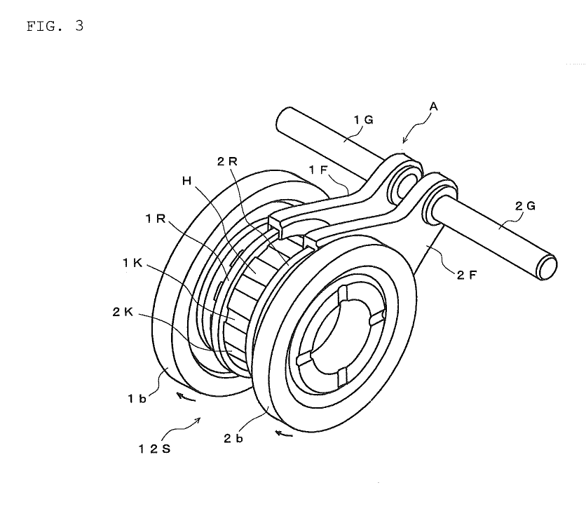

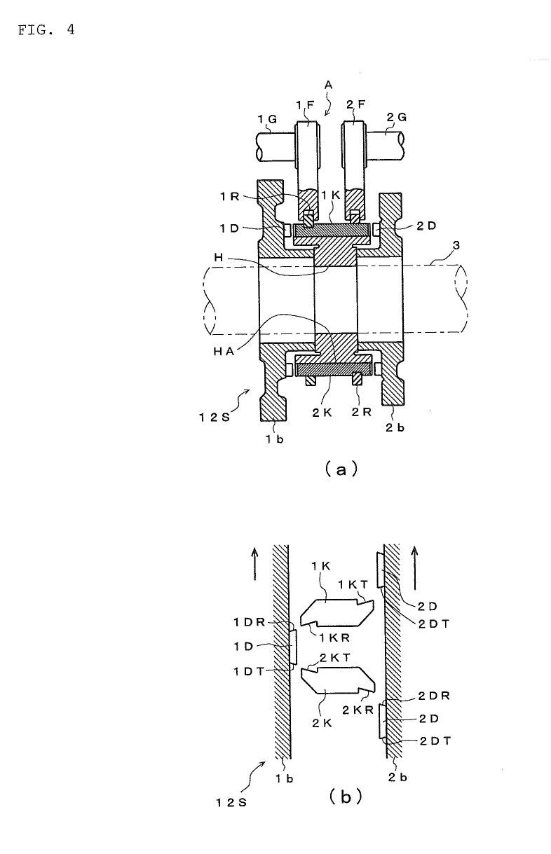

FIG. 2 is an exploded perspective view illustrating the first and second gear selector mechanism 12S of the transmission M. FIG. 3 is a perspective assembly drawing of the first and second gear selector mechanism 12S. FIG. 4A is a sectional view of the first and second gear selector mechanism 12S. FIG. 4B is an illustrative view illustrating dogs 1D and 2D, a first key 1K, and a second key 2K of the first and second gear selector mechanism 12S. The first and second gear selector mechanism 12S includes the dogs 1D, 2D that project respectively from opposing surfaces of the first speed driven gear 1b and the second speed driven gear 2b. The dogs 1D and 2D are provided in respective pluralities at equal intervals in circumferential directions of the respective gears 1b, 2b. The dogs 1D and 2D respectively include leading surfaces (drive gear surfaces) 1DR and 2DR each serving as a front surface in rotation directions of the corresponding gears 1b or 2b, and trailing surfaces (driven gear surfaces) 1DT and 2DT each serving as a rear surface in the rotation directions. The leading surfaces 1DR and 2DR and the trailing surfaces 1DT and 2DT are formed in an inverse tapered shape so as to fan out from a base toward a tip end.

(Hub H)

As illustrated in FIG. 2, the first and second gear selector mechanism 12S includes a hub H that is fixed to the output shaft 3 between the first speed driven gear 1b and the second speed driven gear 2b. A plurality of key grooves HA formed parallel to the axial direction of the output shaft 3 is provided in an outer peripheral surface of the hub H at equal intervals in the circumferential direction. The first key 1K and the second key 2K are held in the key grooves HA to be free to move in the axial direction. The first key 1K and the second key 2K are held in the respective key grooves HA alternately in the circumferential direction. Each key groove HA is formed such that an opening thereof is narrower than a bottom. Thus, when the hub H rotates such that centrifugal force is exerted on the first key 1K and the second key 2K, the first key 1K and the second key 2K do not fly out of the openings of the key grooves HA.

(First Key 1K and Second Key 2K)

As described above, the first and second gear selector mechanism 12S includes the first key 1K and the second key 2K held in the key grooves HA to be free to move in the axial direction. As illustrated in FIG. 4B, the first key 1K has, on an end thereof, an engagement pawl 1KR that engages with the leading surface 1DR of the dog 1D of the first speed driven gear 1b, and, on another end, an engagement pawl 1KT that engages with the trailing surface 2DT of the dog 2D of the second speed driven gear 2b. Similarly, the second key 2K has, on an end thereof, an engagement pawl 2KT that engages with the trailing surface 1DT of the dog 1D of the first speed driven gear 1b, and, on another end, an engagement pawl 2KR that engages with the leading surface 2DR of the dog 2D of the second speed driven gear 2b. The engagement pawls 1KR, 1KT, 2KR and 2KT are formed in an inverse tapered shape in order to improve an engagement performance of the engagement pawls 1KR, 1KT, 2KR and 2KT.

A first sleeve ring 1R and a second sleeve ring 2R are attached to the outer peripheral surface of the hub H to be free to move in the axial direction but incapable of relative rotation in the circumferential direction relative to the hub H. As illustrated in FIG. 2, a plurality of projections 1RA are provided on an inner peripheral surface of the first sleeve ring 1R at equal intervals in the circumferential direction, and the projections 1RA engage with recesses 1KA formed in the first key 1K. As a result, the first sleeve ring 1R and the first key 1K move integrally in the axial direction. Similarly, a plurality of projections 2RA are provided on an inner peripheral surface of the second sleeve ring 2R at equal intervals in the circumferential direction, and the projections 2RA engage with recesses 2KA formed in the second key 2K. As a result, the second sleeve ring 2R and the second key 2K move integrally in the axial direction.

(Actuator A)

The first and second gear selector mechanism 12S includes an actuator A for moving the first key 1K and the second key 2K in the axial direction. The actuator A includes a first shift fork 1F that engages with the first sleeve ring 1R, a first shift rod 1G connected to the first shift fork 1F, and a first driving mechanism (an electric cylinder or the like), not shown in the drawings, that moves the first shift rod 1G in the axial direction. Further, the actuator A includes a second shift fork 2F that engages with the second sleeve ring 2R, a second shift rod 2G connected to the second shift fork 2F, and a second driving mechanism (an electric cylinder or the like), not shown in the drawings, that moves the second shift rod 2G in the axial direction. The first driving mechanism and the second driving mechanism perform gear shifts by moving the first shift rod 1G and the second shift rod 2G in a coordinated fashion in response to computer control corresponding to travel conditions of the vehicle or a shift operation performed on a shift lever or the like by a driver. The gear shifts, which will be described below, can be performed without torque interruption while the startup clutch C remains connected.

(Third and Fourth Gear Selector Mechanism 34S, Fifth and Sixth Gear Selector Mechanism 56S)

The third and fourth gear selector mechanism 34S and the fifth and sixth gear selector mechanism 56S illustrated in FIG. 1 are configured similarly to the first and second gear selector mechanism 12S, and therefore description thereof has been omitted. Note that a dog of the third speed driven gear 3b is denoted by 3D, a dog of the fourth speed driven gear 4b is denoted by 4D, a dog of the fifth speed driven gear 5b is denoted by 5D, and a dog of the sixth speed driven gear 6b is denoted by 6D. Gear shifts at respective speeds using the third and fourth gear selector mechanism 34S and the fifth and sixth gear selector mechanism 56S, which will be described below, can likewise be performed without torque interruption while the startup clutch C remains connected.

(Damping Mechanism W)

As illustrated in FIG. 1, the transmission M includes a damping mechanism W interposed between the input shaft 1 and the intermediate shaft 2. The damping mechanism W absorbs an impact (spike torque) generated when one of the first speed driven gear 1b, the second speed driven gear 2b, the third speed driven gear 3b, the fourth speed driven gear 4b, the fifth speed driven gear 5b, and the sixth speed driven gear 6b is fixed to the output shaft 3 to be incapable of relative rotation by the selector mechanism S (the first and second gear selector mechanism 12S, the third and fourth gear selector mechanism 34S, or the fifth and sixth gear selector mechanism 56S).

The damping mechanism W has a function for causing the input shaft 1 and the intermediate shaft 2 to rotate integrally when torque generated in the input shaft 1 or the intermediate shaft 2 is smaller than a predetermined torque, and causing the input shaft 1 and the intermediate shaft 2 to rotate relatively when the torque equals or exceeds the set torque. The predetermined torque, which serves as a threshold for permitting relative rotation between the input shaft 1 and the intermediate shaft 2, or in other words slippage, is set to be larger than a maximum torque that can be generated in the input shaft 1 or the intermediate shaft 2 when the output shaft 3 is rotated by the engine so as to cause the vehicle to travel, and smaller than the spike torque that can be generated in the input shaft 1 or the intermediate shaft 2 when a gear shift is performed without torque interruption using the selector mechanism S. In so doing, normal vehicle travel using the engine can be performed without impairment, and the spike torque generated during a gear shift can be dampened. The predetermined torque is set at a larger value than the aforesaid maximum torque so as to have a certain degree of leeway relative thereto. However, the leeway is preferably as small as possible. The predetermined torque is set thus so that minor spike torque slightly exceeding the maximum torque can be dampened reliably.

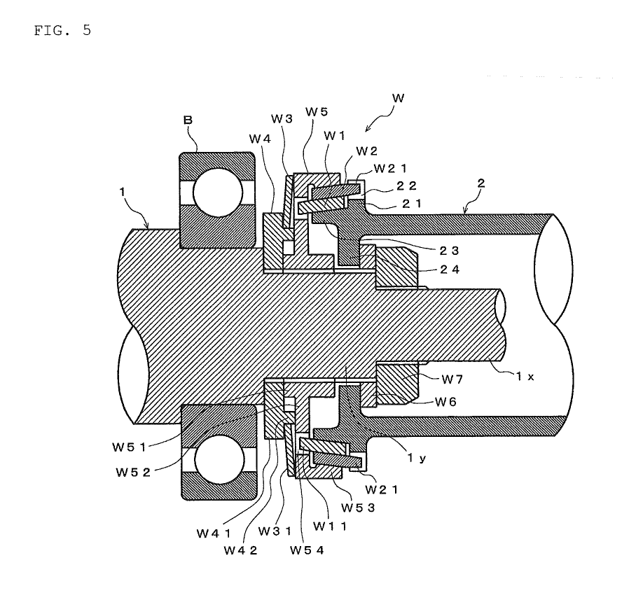

FIG. 5 is a sectional view illustrating the damping mechanism W of the transmission M. The damping mechanism W includes an input shaft friction plate (an inner ring) W1 that rotates integrally with the input shaft 1, an intermediate shaft friction plate (an intermediate ring) W2 that is disposed to overlap the input shaft friction plate W1 and rotates integrally with the intermediate shaft 2, and an elastic member W3 for pressing the intermediate shaft friction plate W2 against the input shaft friction plate W1. The input shaft 1 is supported axially on the transmission case by a bearing B, and includes a medium diameter shaft 1y and the aforesaid projecting shaft 1x, which are inserted into the hollow intermediate shaft 2 (see FIG. 1).

As illustrated in FIG. 5, a spline is formed on an outer peripheral surface of the medium diameter shaft 1y of the input shaft 1, and a retainer W4 and a hub W5 are attached thereto to be incapable of relative rotation. The retainer W4 includes a ring plate-shaped retainer main body W41 attached to the medium diameter shaft 1y, and a spring holder W42 projecting from an intermediate shaft 2 side surface of the retainer main body W41. A conical plate spring W31 constituting the elastic member W3 is attached to the spring holder W42. The hub W5 includes a tubular W51 attached to the medium diameter shaft 1y, a ring plate-shaped hub main body W52 provided on the tubular W51, and a tubular friction surface W53 extending to the intermediate shaft 2 from an outer peripheral end of the hub main body W52. An incline angle of an inner peripheral surface of the friction surface W53 matches an incline angle of an outer peripheral surface of the intermediate shaft friction plate W2 such that the inner peripheral surface of the friction surface W53 contacts the outer peripheral surface of the intermediate shaft friction plate W2 substantially evenly. A plurality of holding holes W54 are formed in the hub main body W52 at intervals in the circumferential direction.

The input shaft friction plate W1 is a ring-shaped member that is formed in a conical plate shape and has a predetermined length in the axial direction of the input shaft 1. The input shaft friction plate W1 is formed to decrease in diameter gradually from an intermediate shaft 2 (a right side in FIG. 5) end surface toward an input shaft 1 (a left side in FIG. 5) end surface, while an inner peripheral surface and an outer peripheral surface of the input shaft friction plate W1 are formed to incline relative to the axial direction of the input shaft 1. A plurality of holding pieces W11 that engage with the respective holding holes W54 in the hub W5 are formed in one end of the input shaft friction plate W1 at intervals in the circumferential direction. When the holding pieces W11 of the input shaft friction plate W1 are engaged with the holding holes W54 in the hub W5, the hub W5 and the input shaft friction plate W1 rotate integrally.

The intermediate shaft 2 is hollow, and a flange 21 is formed on an outer peripheral surface thereof. A plurality of holding grooves 22 are formed in the flange 21 at intervals in the circumferential direction. Holding pieces W21 formed on the intermediate shaft friction plate W2, to be described below, engage with the holding grooves 22. A ring-shaped friction surface 23 is formed on an end of the intermediate shaft 2 to extend to the input shaft 1. An incline angle of an outer peripheral surface of the friction surface 23 matches an incline angle of an inner peripheral surface of the input shaft friction plate W1 such that the outer peripheral surface of the friction surface 23 contacts the inner peripheral surface of the input shaft friction plate W1 substantially evenly.

The intermediate shaft friction plate W2 is a ring-shaped member that is formed in a conical plate shape and has a predetermined length in the axial direction of the intermediate shaft 2. The intermediate shaft friction plate W2 is formed to decrease in diameter gradually from an intermediate shaft 2 (the right side in FIG. 5) end surface toward an input shaft 1 (the left side in FIG. 5) end surface, while an inner peripheral surface and an outer peripheral surface of the intermediate shaft friction plate W2 are formed to incline relative to the axial direction of the intermediate shaft 2. The plurality of holding pieces W21 that engage with the respective holding grooves 22 in the intermediate shaft 2 are formed on one end of the intermediate shaft friction plate W2 at intervals in the circumferential direction. When the holding pieces W21 of the intermediate shaft friction plate W2 are engaged with the holding grooves 22 in the intermediate shaft 2, the intermediate shaft 2 and the intermediate shaft friction plate W2 rotate integrally.

The input shaft friction plate W1 and the intermediate shaft friction plate W2 are pressed against each other by the elastic member W3. The elastic member W3 has by the conical plate spring W31 interposed between the retainer W4 and the hub W5. A flange 24 is formed on an inner peripheral surface of the intermediate shaft 2, and a washer W6 contacts the flange 24. When the washer W6 is pressed toward the plate spring W31 by a nut W7 that is screwed to a screw formed in the projecting shaft 1x, the plate spring W31 deflects such that the input shaft friction plate W1 and the intermediate shaft friction plate W2 are pressed against each other. Simultaneously, the inner peripheral surface of the input shaft friction plate W1 is pressed against the friction surface 23 of the intermediate shaft 2, and the outer peripheral surface of the intermediate shaft friction plate W2 is pressed against the friction surface W53 of the hub W5. As a result, the damping mechanism W exhibits the function for causing the input shaft 1 and the intermediate shaft 2 to rotate integrally when the torque generated in the input shaft 1 or the intermediate shaft 2 is smaller than the predetermined torque, and causing the input shaft 1 and the intermediate shaft 2 to rotate relatively when the torque equals or exceeds the predetermined torque. The predetermined torque can be adjusted by modifying a plate thickness of the washer W6 or by modifying the plate spring W31 itself. The damping mechanism W has a so-called friction cone clutch.

(Upshifts)

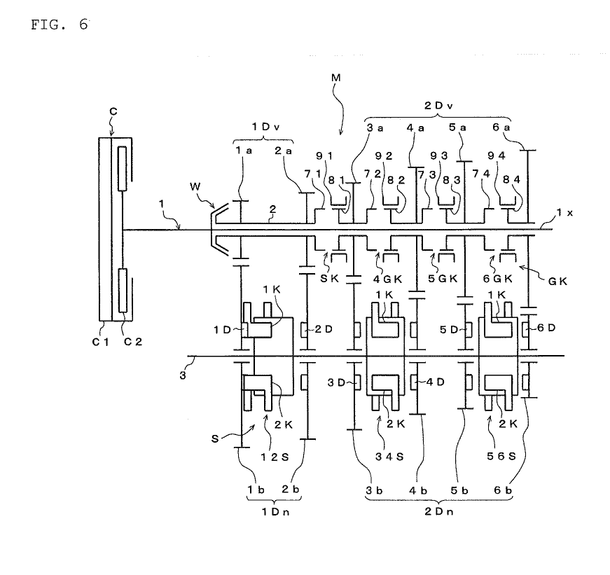

FIG. 6 illustrates the transmission M when a first gear is selected. When the vehicle is started in the first gear, the first key 1K and the second key 2K of the first and second gear selector mechanism 12S are moved to the first speed driven gear 1b with the startup clutch C in a disengaged condition. The startup clutch C is then connected by half clutch control such that the rotation of the input shaft 1 is transmitted to the output shaft 3 via the first speed drive gear 1a, the first speed driven gear 1b, and the first and second gear selector mechanism 12S. At this time, the first key 1K engages with the dog 1D of the first speed driven gear 1b so as to perform torque transmission, while the second key 2K enters a coasting condition not engaged with the dog 1D of the first speed driven gear 1b so as to be capable of moving to the second speed driven gear 2b.

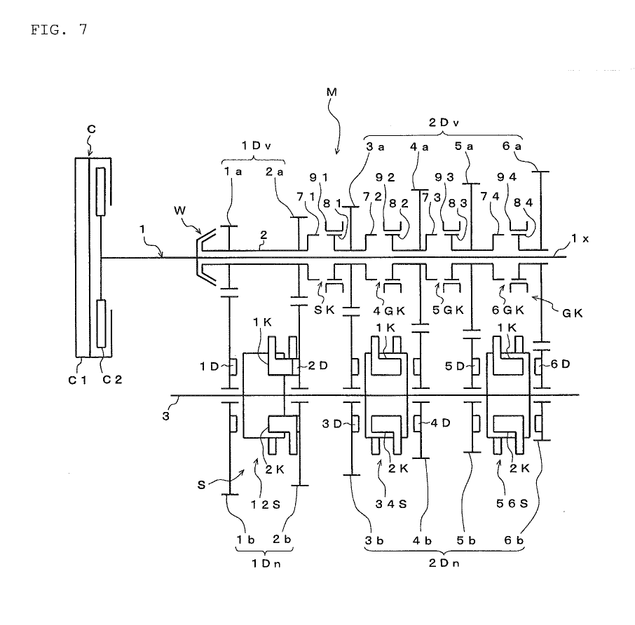

FIG. 7 illustrates the transmission M when a second gear is selected. When an upshift is performed from the first gear to the second gear, the second key 2K (in the coasting condition) of the first and second gear selector mechanism 12S is moved to the second speed driven gear 2b while the startup clutch C remains connected. As a result, the second key 2K engages with the dog 2D of the second speed driven gear 2b such that the upshift from the first gear to the second gear can be achieved without torque interruption. During the upshift, spike torque is generated by a rotation speed difference between the first speed driven gear 1b and the second speed driven gear 2b at the moment of engagement between the second key 2K and the dog 2D of the second speed driven gear 2b, but the spike torque is absorbed and dampened by the damping mechanism W interposed between the intermediate shaft 2 and the input shaft 1. Further, when the second key 2K engages with the dog 2D of the second speed driven gear 2b, the first key 1K is uncoupled from the dog 1D of the first speed driven gear 1b so as to enter the coasting condition, whereby the first key 1K also moves to the second speed driven gear 2b.

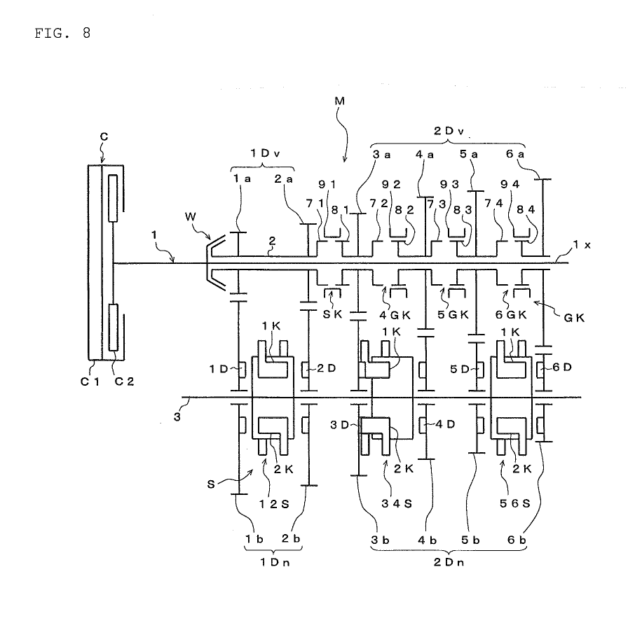

FIG. 8 illustrates the transmission M when a third gear is selected. When an upshift is performed from the second gear to the third gear, the sleeve 91 of the shaft joining mechanism SK is moved to the second speed drive gear 2a such that the sleeve 91 is suspended between the hub 71 and the hub 81, whereby the third speed drive gear 3a rotates integrally with the intermediate shaft 2. The first key 1K and the second key 2K of the third and fourth gear selector mechanism 34S are then moved to the third speed driven gear 3b from neutral positions (positions not engaged with the left and right dogs 3D, 4D) while the startup clutch C remains connected. As a result, the first key 1K of the third and fourth gear selector mechanism 34S engages with the dog 3D of the third speed driven gear 3b so as to perform torque transmission, while the first key 1K and the second key 2K of the first and second gear selector mechanism 12S both enter the coasting condition. Accordingly, the first key 1K and the second key 2K of the first and second gear selector mechanism 12S move to neutral positions (positions not engaged with the left and right dogs 1D and 2D). Thus, the upshift from the second gear to the third gear can be performed without torque interruption. The spike torque generated during the upshift at the moment of engagement between the first key 1K of the third and fourth gear selector mechanism 34S and the dog 3D of the third speed driven gear 3b is absorbed and dampened by the damping mechanism W. Note that at this time, the second key 2K of the third and fourth gear selector mechanism 34S does not engage with the dog 3D of the third speed driven gear 3b (i.e. enters the coasting condition).

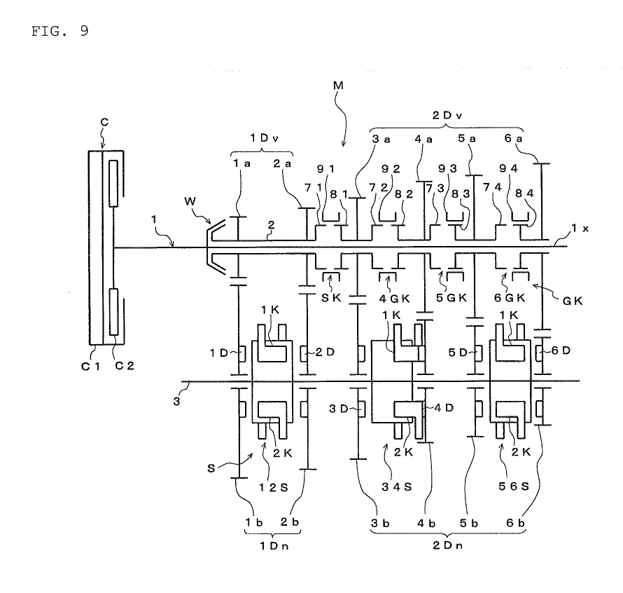

FIG. 9 illustrates the transmission M when a fourth gear is selected. When an upshift is performed from the third gear to the fourth gear, the sleeve 92 of the fourth speed gear joining mechanism 4GK is moved to the third speed drive gear 3a such that the sleeve 92 is suspended between the hub 72 and the hub 82, whereby the fourth speed drive gear 4a rotates integrally with the third speed drive gear 3a. When the third gear is selected, the third speed drive gear 3a and the intermediate shaft 2 are caused to rotate integrally by the sleeve 91 of the shaft joining mechanism SK, and therefore the intermediate shaft 2, the third speed drive gear 3a, and the fourth speed drive gear 4a all rotate integrally. The second key 2K (in the coasting condition) of the third and fourth gear selector mechanism 34S is then moved to the fourth speed driven gear 4b while the startup clutch C remains connected. As a result, the second key 2K engages with the dog 4D of the fourth speed driven gear 4b such that the upshift can be performed without torque interruption. The spike torque generated during the upshift at the moment of engagement between the second key 2K and the dog 4D of the fourth speed driven gear 4b is absorbed and dampened by the damping mechanism W. Further, when the second key 2K engages with the dog 4D of the fourth speed driven gear 4b, the first key 1K enters the coasting condition, whereby the first key 1K also moves to the fourth speed driven gear 4b.

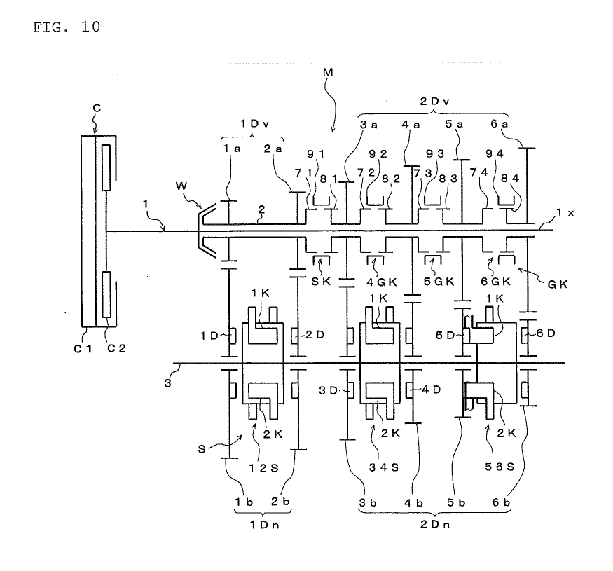

FIG. 10 illustrates the transmission M when a fifth gear is selected. When an upshift is performed from the fourth gear to the fifth gear, the sleeve 93 of the fifth speed gear joining mechanism 5GK is moved to the fourth speed drive gear 4a such that the sleeve 93 is suspended between the hub 73 and the hub 83, whereby the fifth speed drive gear 5a rotates integrally with the fourth speed drive gear 4a. When the fourth gear is selected, the third speed drive gear 3a and the intermediate shaft 2 are caused to rotate integrally by the sleeve 91, while the fourth speed drive gear 4a and the third speed drive gear 3a are caused to rotate integrally by the sleeve 92. Therefore, the intermediate shaft 2, the third speed drive gear 3a, the fourth speed drive gear 4a, and the fifth speed drive gear 5a all rotate integrally. The first key 1K and the second key 2K of the fifth and sixth gear selector mechanism 56S are then moved to the fifth speed driven gear 5b from neutral positions while the startup clutch C remains connected. As a result, the first key 1K of the fifth and sixth gear selector mechanism 56S engages with the dog 5D of the fifth speed driven gear 5b so as to perform torque transmission, while the first key 1K and the second key 2K of the third and fourth gear selector mechanism 34S both enter the coasting condition. Accordingly, the first key 1K and the second key 2K of the third and fourth gear selector mechanism 34S move to the neutral positions. Thus, the upshift from the fourth gear to the fifth gear can be performed without torque interruption. The spike torque generated during the upshift at the moment of engagement between the first key 1K of the fifth and sixth gear selector mechanism 56S and the dog 5D of the fifth speed driven gear 5b is absorbed and dampened by the damping mechanism W. Note that at this time, the second key 2K of the fifth and sixth gear selector mechanism 56S does not engage with the dog 5D of the fifth speed driven gear 5b (i.e. enters the coasting condition).

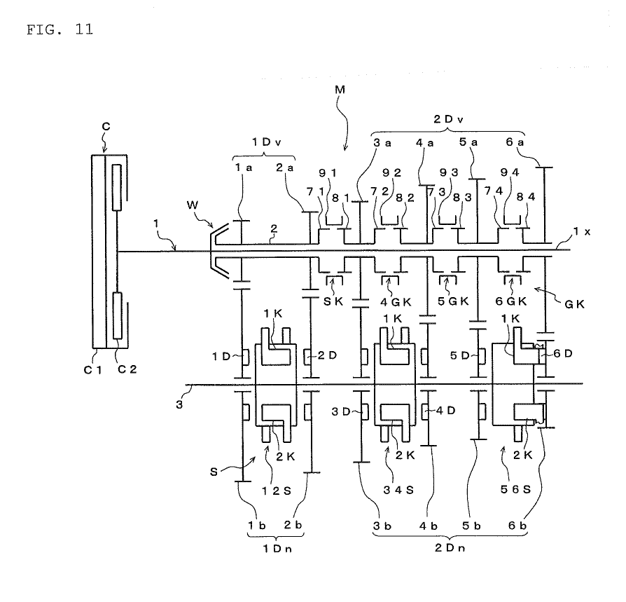

FIG. 11 illustrates the transmission M when a sixth gear is selected. When an upshift is performed from the fifth gear to the sixth gear, the sleeve 94 of the sixth speed gear joining mechanism 6GK is moved to the fifth speed drive gear 5a such that the sleeve 94 is suspended between the hub 74 and the hub 84, whereby the sixth speed drive gear 6a rotates integrally with the fifth speed drive gear 5a. When the fifth gear is selected, the intermediate shaft 2, the third speed drive gear 3a, the fourth speed drive gear 4a, and the fifth speed drive gear 5a rotate integrally, and therefore the intermediate shaft 2, the third speed drive gear 3a, the fourth speed drive gear 4a, the fifth speed drive gear 5a, and the sixth speed drive gear 6a all rotate integrally. The second key 2K (in the coasting condition) of the fifth and sixth gear selector mechanism 56S is then moved to the sixth speed driven gear 6b while the startup clutch C remains connected. As a result, the second key 2K engages with the dog 6D of the sixth speed driven gear 6b such that the upshift can be performed without torque interruption. The spike torque generated during the upshift at the moment of engagement between the second key 2K and the dog 6D of the sixth speed driven gear 6b is absorbed and dampened by the damping mechanism W. Further, when the second key 2K engages with the dog 6D of the sixth speed driven gear 6b, the first key 1K enters the coasting condition, whereby the first key 1K also moves to the sixth speed driven gear 6b.

(Downshifts)

Upshifts were described above. Downshifts, meanwhile, are performed using reverse procedures. More specifically, when a downshift is performed from the sixth gear to the fifth gear, as illustrated in FIG. 10, the sleeve 94 of the sixth speed gear joining mechanism 6GK is moved to the sixth speed drive gear 6a such that the sleeve 94 is uncoupled from the hub 74 and the sixth speed drive gear 6a is disconnected from the rotation of the fifth speed drive gear 5a. At this time, the fifth speed drive gear 5a is coupled to the fourth speed drive gear 4a by the sleeve 93, the fourth speed drive gear 4a is coupled to the third speed drive gear 3a by the sleeve 92, and the third speed drive gear 3a is coupled to the intermediate shaft 2 by the sleeve 91. In this condition, the key in the coasting condition (the second key 2K, for example), from among the first key 1K and the second key 2K of the fifth and sixth gear selector mechanism 56S, is moved to the fifth speed driven gear 5b while the startup clutch C remains connected. As a result, the second key 2K engages with the dog 5D of the fifth speed driven gear 5b such that the downshift can be performed without torque interruption. The spike torque generated during the downshift at the moment of engagement between the second key 2K and the dog 5D of the fifth speed driven gear 5b is absorbed and dampened by the damping mechanism W. Further, when the second key 2K engages with the dog 5D of the fifth speed driven gear 5b, the first key 1K enters the coasting condition, whereby the first key 1K also moves to the fifth speed driven gear 5b.

When a downshift is performed from the fifth gear to the fourth gear, as illustrated in FIG. 9, the sleeve 93 of the fifth speed gear joining mechanism 5GK is moved to the fifth speed drive gear 5a such that the fifth speed drive gear 5a is disconnected from the rotation of the fourth speed drive gear 4a. In this condition, the first key 1K and the second key 2K of the third and fourth gear selector mechanism 34S are moved to the fourth speed driven gear 4b from the neutral positions while the startup clutch C remains connected, while the first key 1K and the second key 2K of the fifth and sixth gear selector mechanism 56S are moved to the neutral positions. As a result, the downshift can be performed without torque interruption. The spike torque generated during the downshift is absorbed and dampened by the damping mechanism W.

When a downshift is performed from the fourth gear to the third gear, as illustrated in FIG. 8, the sleeve 92 of the fourth speed gear joining mechanism 4GK is moved to the fourth speed drive gear 4a such that the fourth speed drive gear 4a is disconnected from the rotation of the third speed drive gear 3a. In this condition, the first key 1K and the second key 2K of the third and fourth gear selector mechanism 34S are moved to the third speed driven gear 3b while the startup clutch C remains connected. As a result, the downshift can be performed without torque interruption. The spike torque generated during the downshift is absorbed and dampened by the damping mechanism W.

When a downshift is performed from the third gear to the second gear, as illustrated in FIG. 7, the sleeve 91 of the shaft joining mechanism SK is moved to the third speed drive gear 3a such that the third speed drive gear 3a is disconnected from the rotation of the intermediate shaft 2. In this condition, the first key 1K and the second key 2K of the first and second gear selector mechanism 12S are moved to the second speed driven gear 2b and the first key 1K and the second key 2K of the third and fourth gear selector mechanism 34S are moved to the neutral positions while the startup clutch C remains connected. As a result, the downshift can be performed without torque interruption. The spike torque generated during the downshift is absorbed and dampened by the damping mechanism W.

When a downshift is performed from the second gear to the first gear, as illustrated in FIG. 6, the first key 1K and the second key 2K of the first and second gear selector mechanism 12S are moved to the first speed driven gear 1b while the startup clutch C remains connected. As a result, the downshift can be performed without torque interruption. The spike torque generated during the downshift is absorbed and dampened by the damping mechanism W.

(Actions/Effects)

In the transmission M according to this embodiment, as described above, during a gear shift, one of the first driven gears 1Dn (the first speed driven gear 1b and the second speed driven gear 2b) and the second driven gears 2Dn (the third speed driven gear 3b, the fourth speed driven gear 4b, the fifth speed driven gear 5b, and the sixth speed driven gear 6b) inserted into the output shaft 3 to be free to rotate is fixed to the output shaft 3 to be incapable of relative rotation by the selector mechanism S (the first and second gear selector mechanism 12S, the third and fourth gear selector mechanism 34S, or the fifth and sixth gear selector mechanism 56S). An impact (spike torque) generated at this time is absorbed by the shared damping mechanism W interposed between the input shaft 1 and the intermediate shaft 2.

The damping mechanism W is interposed between the input shaft 1 and the intermediate shaft 2, and can therefore be shared among all of the gear positions so as to be able to respond to spike torque generated when any one of the first speed driven gear 1b, the second speed driven gear 2b, the third speed driven gear 3b, the fourth speed driven gear 4b, the fifth speed driven gear 5b, and the sixth speed driven gear 6b is fixed to the output shaft 3 to be incapable of relative rotation. Hence, in comparison with a case such as that of the related art, in which a damping mechanism is provided for each gear position, a reduction in an axial direction dimension of the transmission M and a reduction in cost can be achieved.

Further, in contrast to the related art, the damping mechanism W is not incorporated into a gear interior, and therefore a damping function is not limited by dimensional restrictions occurring when the damping mechanism is incorporated into a gear. Moreover, reductions in a thickness and a rigidity of the gear occurring when the damping mechanism W is incorporated into the gear interior can be avoided, and therefore a reduction in meshing precision and an increase in meshing noise due to the reduction in rigidity do not occur.

Furthermore, in the transmission M according to this embodiment, during gear shifts from the first gear to the gear speed and from the second gear to the first gear, the intermediate shaft 2 is uncoupled from the third speed drive gear 3a by the shaft joining mechanism SK. Therefore, the high speed drive gears from the third speed drive gear 3a up to the fourth, fifth, and sixth speed drive gears 4a, 5a and 6a and the high speed driven gears from the third speed driven gear 3b up to the fourth, fifth, and sixth speed driven gears 4b, 5b and 6b that are meshed thereto are not co-rotated by the engine. Hence, when the first key 1K or the second key 2K of the first and second gear selector mechanism 12S engages with the dog 1D of the first speed driven gear 1b or the dog 2D of the second speed driven gear 2b during a gear shift between the first gear and the second gear, the number of gears rotated in conjunction with these gears can be minimized, and as a result, inertia in the rotation of the respective gears, which causes the spike torque to increase, can be minimized.

During an upshift to the third gear, the intermediate shaft 2 and the third speed drive gear 3a are coupled by the shaft joining mechanism SK, whereas the third speed drive gear 3a and the fourth speed drive gear 4a are uncoupled by the fourth speed gear joining mechanism 4GK. Therefore, the high speed drive gears from the fourth speed drive gear 4a up to the fifth and sixth speed drive gears 5a, 6a and the high speed driven gears from the fourth speed driven gear 4b up to the fifth and sixth speed driven gears 5b, 6b that are meshed thereto are not co-rotated by the engine. As a result, inertia in the rotation of the respective gears, which causes the spike torque to increase, can be minimized during a gear shift between the second gear and the third gear.

During subsequent upshifts to the fourth, fifth, and sixth gears, the fourth speed drive gear 4a, the fifth speed drive gear 5a, and the sixth speed drive gear 6a are coupled to the intermediate shaft 2 successively by the fourth speed gear joining mechanism 4GK, the fifth speed gear joining mechanism 5GK, and the sixth speed gear joining mechanism 6GK, leading to an increase in the number of co-rotated gears and a corresponding increase in inertia. However, the spike torque generated during a gear shift performed at a high speed is smaller than the spike torque generated during a gear shift performed at a low speed to begin with due to a step ratio between gear shift gear ratios, and therefore the increase in inertia does not pose a large problem.

In other words, according to the transmission M, when the first key 1K or the second key 2K of the selector mechanism S engages with a dog of a gear during a gear shift at a low speed, including a gearshift between the first gear and the gear speed during which large spike torque is generated, the number of gears rotated in conjunction with the gear can be minimized. Hence, inertia in the rotation of the respective gears, which causes the spike torque to increase, can be minimized during a gear shift at a low speed, and as a result, noise and vibration can be suppressed effectively.

In short, with the transmission according to the present invention, reductions in the cost and the size of the transmission can be realized while securing a sufficient damping function for dampening spike torque generated during gear shifts performed in respective gear positions.

The present invention is not limited to the above-described embodiments, and permits various modifications and alterations within the technical scope of the invention. For example, the fourth speed drive gear 4a, the fifth speed drive gear 5a, the sixth speed drive gear 6a, the fourth speed driven gear 4b, the fifth speed driven gear 5b, the sixth speed driven gear 6b, the fourth speed gear joining mechanism 4GK, the fifth speed gear joining mechanism 5GK, and the sixth speed gear joining mechanism 6GK may be omitted to form a transmission having three gear positions. Further, the configuration of the selector mechanism S is not limited to the configuration described above, and a known conventional selector mechanism may be employed instead.

The present invention can be used mainly as a transmission for a vehicle.

What is claimed is:

1. A transmission comprising:
an input shaft for receiving rotation of an engine;
an intermediate shaft disposed concentrically with the input shaft to be capable of rotating relative thereto;
an output shaft disposed parallel to the intermediate shaft;
at least one first drive gear fixed to the intermediate shaft;
one or a plurality of second drive gears disposed in series to be respectively free to rotate on an axis extending from a shaft end of the intermediate shaft;
a shaft joining mechanism to join a gear that is closest to the intermediate shaft, from among the plurality of second drive gears, to the intermediate shaft to be incapable of relative rotation;
at least one first driven gear inserted into the output shaft to be free to rotate and meshes with the at least one first drive gear;
one or a plurality of second driven gears that is inserted into the output shaft to be free to rotate and meshes with the one or plurality of second drive gears;
a selector mechanism to fix one of the at least one first driven gear and the one or plurality of second driven gears to the output shaft to be incapable of relative rotation; and
a damping mechanism interposed between the input shaft and the intermediate shaft to absorb an impact generated when one of the at least one first driven gear and the one or plurality of second driven gears is fixed to the output shaft to be incapable of relative rotation by the selector mechanism.

2. The transmission according to claim 1, wherein:
the second drive gear is provided in a plurality; and
the transmission further comprising a gear joining mechanism to join adjacent second drive gears to each other to be incapable of relative rotation.

3. The transmission according to claim 2, wherein the second drive gears are disposed such that gear ratios thereof decrease gradually away from an engine end of the input shaft.

4. The transmission according to claim 1, wherein the damping mechanism has a function for causing the input shaft and the intermediate shaft to rotate integrally when a torque generated in the input shaft or the intermediate shaft is smaller than a predetermined torque, and causing the input shaft and the intermediate shaft to rotate relatively when the torque equals or exceeds the predetermined torque.

5. The transmission according to claim 1, wherein the damping mechanism comprises:
an input shaft friction plate that rotates integrally with the input shaft;
an intermediate shaft friction plate that is disposed to overlap the input shaft friction plate and rotates integrally with the intermediate shaft; and
an elastic member to press the intermediate shaft friction plate against the input shaft friction plate.

6. The transmission according to claim 1, wherein the intermediate shaft is hollow,
the input shaft penetrates the hollow intermediate shaft and includes a projecting shaft that projects from an end thereof, and
the one or plurality of second drive gears is inserted into the projecting shaft to be free to rotate.

7. The transmission according to claim 1, wherein the selector mechanism comprises:
dogs that project respectively from opposing surfaces of adjacent gears, from among the at least first driven gear and the one or plurality of second driven gears inserted into the output shaft to be free to rotate;
a hub fixed to the output shaft between the adjacent gears;
a first key held on the hub to be free to move in an axial direction of the output shaft, one end of which can be engaged with a leading surface of the dog projecting from one of the adjacent gears and another end of which can be engaged with a trailing surface of the dog projecting from the other adjacent gear;
a second key held on the hub to be free to move in the axial direction of the output shaft, one end of which can be engaged with the trailing surface of the dog projecting from one of the adjacent gears and another end of which can be engaged with the leading surface of the dog projecting from the other adjacent gear; and
an actuator to move the first key and the second key in the axial direction of the output shaft.

8. The transmission according to claim 7, wherein a plurality of key grooves extending in the axial direction are formed in an outer peripheral surface of the hub at intervals in a circumferential direction, and
the first key and the second key are held in the key grooves alternately in the circumferential direction.
